(19) United States
(12) Patent Application Publication
(10) Pub. No.: US 2023/0043445 A1
(43) Pub. Date: Feb. 9, 2023

(54) MECHANISM FOR AUTOMATIC OPENING OF ROLLING DOORS IN CASE OF EMERGENCY

(71) Applicant: DUC MANH LE, Hai Phong (VN)

(72) Inventor: DUC MANH LE, Hai Phong (VN)

(73) Assignee: DUC MANH LE, Hai Phong (VN)

(21) Appl. No.: 17/909,407

(22) PCT Filed: Mar. 5, 2021
(86) PCT No.: PCT/VN2021/000005

§ 371 Date: Sep. 5, 2022

(30) Foreign Application Priority Data
Mar. 6, 2020 (VN) 1-2020-01303

(51) Int. Cl. E06B 9/60

(52) U.S. Cl. CPC E06B 9/60; E06B 9/70

(57) ABSTRACT

The present invention relates to a mechanism for automatic opening of rolling doors (20) in case of emergency consists of: a roller (21) that is a hollow round roller and has at least one first locating hole (211) which is formed at an one end of the roller; a rotation axis (22) has a diameter smaller than the diameter of the roller (21) and coaxial rotatable inside the roller (21) and has two rotation ends (222) outside of the roller; at least one spring (24) has an one end (241) fixed to the rotation axis (22) and the other end (242) is fixed to the internal surface of the roller (21), when the rotation axis (22) rotates relatively against the roller (21) in the opposite direction of the rolling door body so that, when convoluted spring (24) generates elastic accumulated energy of spring (24); an elastic accumulated energy fixing unit (25) that is placed on a rotation end (222) of the rotation axis (21) and has a first locating hole (211) of the roller (21) to fix elastic accumulated energy; and an activator (26) activates to release elastic accumulated energy, thereby it produces the efficiency of automatic opening of the rolling door.

### FIELD OF THE INVENTION

The present invention relates to rolling doors, more particularly to a mechanism for automatic opening of rolling doors in case of emergency, this mechanism which has a simple structure, is easy to install and operates efficiently.

### DESCRIPTION OF THE RELATED ART

Nowadays, rolling doors play an important role in the strong development of modern architecture thanks to their convenience and aesthetics. Rolling doors have been developed more properly and conveniently under all conditions and in all situations or incidents.

However, in some incidents such as fire, emergency exit via a rolling door is not always easy although the rolling door is often equipped with an uninterruptible power supply (UPS) system or a mechanism for manual opening. In case of fire, the uninterruptible power supply system and the engine are easy to blow out, and the mechanism for manual opening requires some manipulations and enough force, not to mention the fact that the operation is impossible due to the heat of the pull chain.

Specifically, as shown in FIG. 1, a conventional rolling door consists of a roller 1 that formed with two ends 11, at least two rolling pulleys 2 that are fixed on the external surface of the roller 1, a body 3 that is composed of many laths/foils and is rolled/unrolled on at least two rolling pulleys 2, a pair of supporting racks 4 that is mounted on a wall to support the roller 1, an engine 5 that is placed on a supporting rack 4, and a transfer mechanism 6 that links an end 11 of the roller 1 to the engine 5 to roll/unroll the body 3; an uninterruptible power supply system 7 that is used to supply power to the engine 5 in case of power failure; and a manual opening/closing mechanism 8 that consists of the pull chain 81 which is used to roll/unroll (open/close) the body 3 in case of engine/power failure.

According to the structure as shown in FIG. 1, the rolling door is opened by the engine 5 to which power is supplied by the uninterruptible power supply system/grid electricity or by the manual opening/closing mechanism 8 by pulling the chain 81. Hence, in case of fire, the engine 5 and the uninterruptible power supply system 7 blow out, the pull chain 81 of the manual opening/closing mechanism 8 is heated, and the opening of the body 3 is impossible.

Therefore, there is a demand for a mechanism for automatic opening of rolling doors in case of emergency such as fire that operates efficiently, is easy to operate, and has a simple structure for easy installation and costs properly.

### DISCLOSURE

### Technical Problem

An object of the present invention is to provide a mechanism for automatic opening of rolling doors in case of emergency such as fire. The mechanism responds to efficient operation, is easy to operate but have a simple construction to facilitate easy installation and at a reasonable cost.

In order to achieve the above-mentioned object, the present invention provides a mechanism for automatic opening of rolling doors (20) in case of emergency consists of:

a roller (21) that is a hollow round roller and is made up of at least one first locating hole (211) which is formed at an one end of the roller;

a rotation axis (22) has a diameter smaller than the diameter of the roller (21) and is rotatable according to the roller (21) and protrudes from two ends of the roller to form two rotation ends (222);

at least one dividing partition (23) is fixed in the hollow compartment of the roller (21) to divide the hollow compartment of the roller (21) into two hollow compartments;

at least one spring (24) that is placed in two hollow compartments of the roller (21), wherein each spring (24) has an one end (241) fixed to the rotation axis (22) and other end (242) is fixed to the internal surface of the roller (21), and the rotation axis (22) rotates relatively against the roller (21) in the opposite direction of the rolling door body so that, when spring (24) convolutes, elastic accumulated energy of spring (24) will be generated;

an elastic accumulated energy fixing unit (25) that is placed on a rotation end (222) of the rotation axis (21) and there is a first locating hole (211) of the roller (21) to fix elastic accumulated energy of spring (24); and

an activator (26) that is used to release elastic accumulated energy of spring to ensure the efficiency of automatic opening of the rolling door.

### BRIEF DESCRIPTION OF DRAWINGS

FIG. 1 is a perspective view of a conventional rolling door;

FIG. 2 is a cross-section view that shows a mechanism for automatic opening of a rolling door in case of emergency according to a preferred embodiment of the invention; and

FIG. 3 is a right view of FIG. 2.

### MODE FOR INVENTION

Here after, the present invention will be described in detail through the preferred embodiments of the present invention and attached drawings, but it should be understood that the invention is not limited therein. The attached drawings are simple drawings that merely illustrate the principle and technical nature of the present invention, so in fact it can be modified or improve similarly but not beyond the scope of the present invention as defined in the below claims.

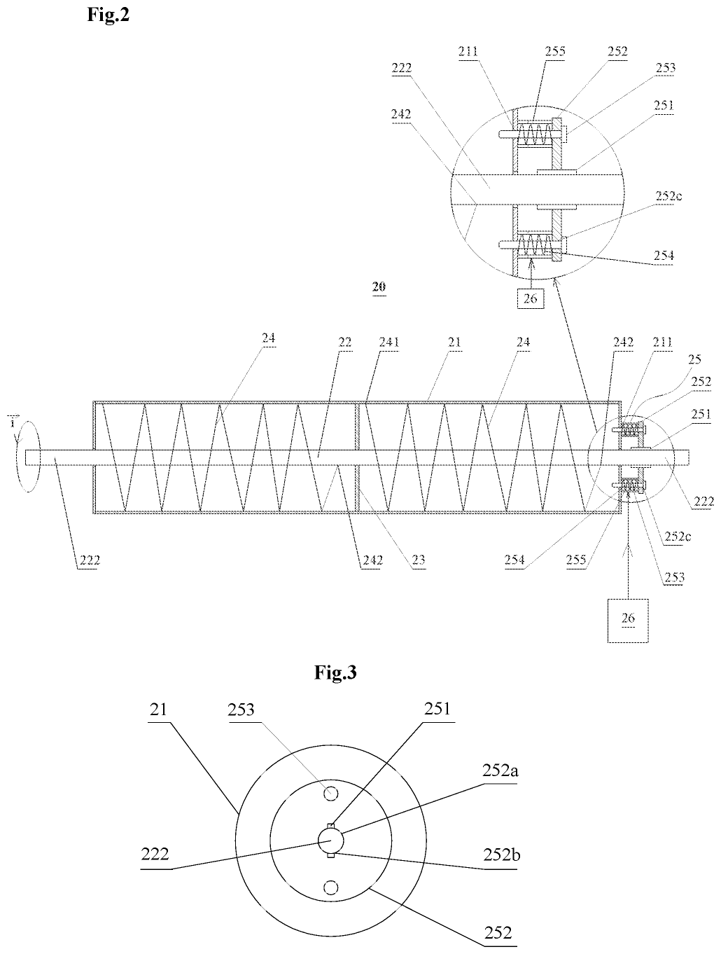

As shown in FIG. 2, a mechanism for automatic opening of rolling doors 20 in case of emergency (hereinafter referred to as automatic opening mechanism 20) consists of a hollow roller 21 that has a predetermined diameter and is made up of two locating holes 211 which are formed at an end of the roller; a rotation axis 22 has a diameter smaller than the diameter of the roller 21 and can rotate according to the roller 21 and protrudes from two ends of the roller to form two rotation ends 222; a dividing partition 23 is fixed in the hollow compartment of the roller 21 to divide the hollow compartment of the roller 21 into two hollow compartments; two springs 24 that are placed in two hollow compartments of the roller 21, in which each spring 24 is inserted outside the rotation axis 22 and has an end 241 that is fixed to the rotation axis 22 and the other end 242 is fixed to the internal surface of the roller 21; an elastic accumulated energy fixing unit 25 that is placed on a rotation end 222 of the rotation axis 22 and there is a first locating hole 211 of the roller 21; and an activator 26 that is used to activate the automatic opening mechanism 20 for opening the rolling door.

According to another preferential alternative of the invention, the hollow compartment of the roller 21 can be divided into more or less than two hollow compartments inside the roller 21 by one or more dividing partitions 23; therefore, there may be more or less than two springs 24, depending on elastic accumulated energy of springs 24 are required to form the roller 21 (as detailed below).

As shown in FIG. 2 and FIG. 3, a elastic accumulated energy fixing unit 25 consists of a pair of locating keys 251 that are fixed on the external surface of a rotation end 222 of the rotation axis 22; a locating disc 252 that is a round disc with a hole 252a with a diameter large enough to pass through the rotation end 222, two locating key holes 252b are formed to pass through two locating keys 251, and secondary locating holes 252c are concentric to two first locating holes 211 of the roller 21; and two locating pins 253 in the form of non-threaded bolt that pass through two secondary locating holes 252c of the locating disc 252 and two first locating holes 211 of the roller 21 to fix elastic accumulated energy of springs 24 in case of convolution of springs 24 (as detailed below).

In addition, according to another preferential alternative of the invention, pin push springs 254 can be replaced with an explosive (explosion will push the locating pin 253 out of first locating holes of the roller 21; and normally compressive pin push springs 254 can be inserted outside the locating pins 253 outside the locating disc 252 provided that, when decompressed, normally compressive pin push springs 254 will push the locating pin 253 out of the first locating pin hole 211 of the roller 21.

To push two locating pins 253 out of two first locating holes 211 of the roller 21, according to a preferential alternative of the invention, two normally compressive pin push springs 254 are placed outside each locating pin 253 and between an end of the roller 21 and the locating disc 25; and units holding the pin push spring 255 to ensure the normal compression of pin push springs 254. According to a preferential alternative, the unit holding the pin push spring 255 can consist of a clutch, adhesive, retention string, and explosion activator.

According to a preferential alternative, the activator 26 can consists of a hitch string that is used to release the clutch, decompress the adhesive, break the retention string, or activate explosion.

The operating principle/efficiency of the invention is detailed below.

To ensure the efficiency of automatic opening of rolling doors in case of emergency such as fire, the automatic opening mechanism 20 of the invention is pre-assembled and operates as follows:

Firstly (at the time of installation of the rolling door), elastic accumulated energy of two springs 24 are generated by rotating the rotation axis 22 relatively against the roller 21 in the opposite direction of the rolling door body (direction in FIG. 2, i.e. the rolling door opening/closing direction), for example, by the engine, specifically, when the rotation axis 22 rotates relatively against the roller 21, springs 24 with an end 241 are fixed to the rotation axis 22 and the other end 242 that is fixed to the internal surface of the roller 21 and convolutes will generate elastic accumulated energy of springs 24.

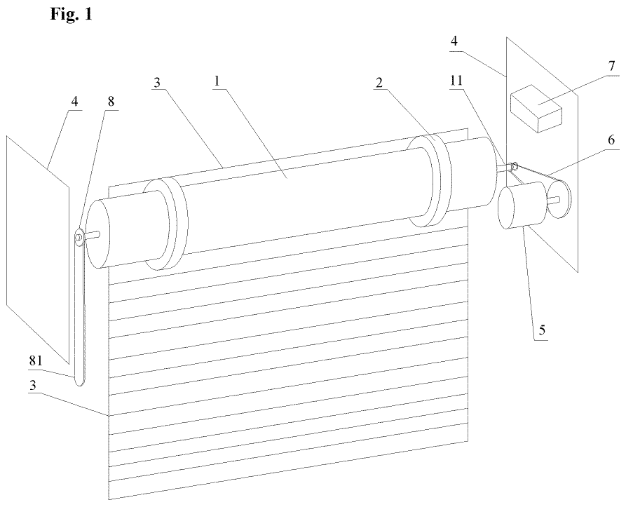

Then, elastic accumulated energy of springs 24 is fixed by elastic accumulated energy fixing unit 25, specifically, the locating disc 252 is inserted to the rotation end 222 and a pair of locating keys 251 and then two locating pins 253 pass through two secondary locating holes 252c of the locating disc 252, two pin push springs 254 and two first locating holes 211 of the roller 21. In this case, the roller 21 and the rotation axis 22 are fixed to each other to form a unit similar to a roller 1 of the rolling door as shown in FIG. 1.

Next, two pin push springs 254 are compressed by a clutch 255, and then adjust the position of the locating disc 252 and locating pins 253 at a proper position so that, when two pin push springs 254 are decompressed, locating pins 253 will be pushed out of first locating holes 211 of the roller 21.

In case of emergency such as failure or fire, the activator 26 will release the clutch 255 to decompress two pin push springs 255 and then push locating pins 253 out of first locating holes 211 of the roller 21. In this case, elastic accumulated energy of springs 24 will cause the roller 21 to rotate on the rotation axis 22 in the rolling direction of the rolling door body to open the rolling door automatically.

Although the present invention is detailed through the preferred embodiment of the present invention, various modifications and enhancements may be made without departing from the spirit and scope of the invention by the skilled in the art. Accordingly, the invention is not to be limited except as by the appended claims. For example, the invention does not limit the number of first locating holes 211, secondary locating holes 252c and locating pin 253 provided that such number is enough to locate/prevent elastic accumulated energy of springs. In addition, the number of locating keys 251 may be enough to locate the locating disc 252.

### INDUSTRIAL APPLICABILITY

Thanks to the use of spring 24 that has an end fixed to the rotation axis 22 and the other end 242 fixed to the internal surface of the roller 21, when the rotation axis 22 rotates, spring 24 will convolute, and elastic accumulated energy will be generated, causing the roller 21 to rotate to roll/lift the rolling door body in case of emergency such as fire.

1. A mechanism for automatic opening of rolling doors (20) in case of emergency consists of:
a roller (21) that is a hollow round roller and is made up of at least one first locating hole (211) which is formed at an end of the roller;
a rotation axis (22) has a diameter smaller than the diameter of the roller (21) and can rotate according to the roller (21) and protrudes from two ends of the roller to form two rotation ends (222);
at least one dividing partition (23) is fixed in the hollow compartment of the roller (21) to divide the hollow compartment of the roller (21) into two hollow compartments;
at least one of the at least two springs (24) is placed in each of said two hollow compartments of the roller (21), in which each spring (24) has an end (241) fixed to the rotation axis (22) and the other end (242) is fixed to the internal surface of the roller (21); and the rotation axis (22) rotates relatively against the roller (21) in the opposite direction of the rolling door body so that, when spring (24) convolutes, elastic accumulated energy of spring (24) will be generated;
an elastic accumulated energy fixing unit (25) that is placed on a rotation end (222) of the rotation axis (22) and there is a first locating hole (211) of the roller (21) to fix elastic accumulated energy of spring (24); and
an activator (26) that is used to release elastic accumulated energy of spring to ensure the efficiency of automatic opening of the rolling door.

2. The mechanism as claimed in claim 1, wherein the elastic accumulated energy fixing unit (25) consists of at least one locating key (251) that is fixed on the external surface of a rotation end (222) of the rotation axis (22); a locating disc (252) that is a round disc with a hole (252a) with a diameter large enough to pass through the rotation end (222), at least one locating key hole (252b) is formed to pass through at least one locating key (251), and at least one secondary locating hole (252c) are concentric to at least one first locating hole (211) of the roller (21); and at least one locating pin (253) in the form of non-threaded bolt that pass through at least one secondary locating hole (252c) of the locating disc (252) and at least one first locating hole (211) of the roller (21).

3. The mechanism as claimed in claim 2, wherein the elastic accumulated energy fixing unit (25) consists of at least one pin push unit (2545) that is placed between an end of the roller (21) and the locating disc (25) to push the locating pin (253) out of at least the first locating hole (211) of the roller (21) when the activator (26) operates to release elastic accumulate energy of the spring to ensure the efficiency of automatic opening of the rolling door.

4. The mechanism as claimed in claim 3, wherein the pin push unit (254) consists of a normally compressive spring and explosive.

5. The mechanism as claimed in claim 2, wherein the said elastic accumulated energy fixing unit (25) further consists of a retention unit (255) to hold the pin push unit (254), in which the retention unit (255) is made up of a clutch, adhesive, retention string, and explosion activator head.
